(19) United States
(12) Patent Application Publication
(10) Pub. No.: US 2019/0037813 A1
(43) Pub. Date: Feb. 7, 2019

(54) Pressure Activated Bird Entertainment and Treat Dispensing System

(71) Applicant: Lois C. Milner, Chatsworth, CA (US)

(72) Inventor: Lois C. Milner, Chatsworth, CA (US)

(21) Appl. No.: 15/667,047

(22) Filed: Aug. 2, 2017

(51) Int. Cl. A01K 39/012; A01K 29/00

(52) U.S. Cl. CPC A01K 39/012; A01K 29/005

(57) ABSTRACT

A pressure activated bird entertainment and treat dispensing system (PBETS) that provides stimulation for a bird, as well as for a bird owner. The PBETS is a themed structure that is placed within a birdcage, or outside of a birdcage. The structure is either horizontally or vertically oriented and has a design based on a theme such as an outdoor scene, an indoor scene, a nature scene, an amusement park ridge design, or an artistic design. Each structure presents multiple geometric and non-geometric shapes, curves and edges. A bird applies pressure from a beak, claw, foot or from weight onto a sensor, which activates a treat release mechanism. Preferably a food treat is released and passes through a treat tube to a location from which the bird can access the treat. The treat release mechanism can either be manually operated or motor driven. A motor also operates various elements on the structure such as moving components, lights or sounds from a speaker.

### TECHNICAL FIELD

The invention generally pertains to pet bird products, and more particularly to a pressure activated bird entertainment and treat dispensing system that presents a food treat to a bird after the bird performs a pressure-requiring action on a structure.

### BACKGROUND ART

Throughout the world many types of animals are kept as domestic pets. Dogs and cats are the two most predominant animals that are chosen as pets, yet other animals including reptiles, rodents and birds are also choices for pets. Of all the animals, birds are one of the most interesting to have as a pet. Some individuals claim that it is not appropriate to have a bird as a pet, since birds, who naturally travel by flying, are typically housed within a cage which restricts their ability to fly. Other animal experts have stated that a bird as a pet is actually a good option, and that even though a bird does live the majority of time in a cage, the bird can experience a comfortable quality of life.

The main reasons for this are because bird owners, like most pet owners, care about the health and well-being of their bird(s). It is true that bird ownership can be more demanding than dog or cat ownership. This is because birds, such as a parrot for example, are intelligent and inquisitive animals. So, in addition to providing a consistent supply of food and water, a bird owner must ensure his/her bird is also provided with entertainment, treat or stimulus. Simply observing the outside environment from within a cage is not enough.

As a result of this product have been developed specifically to entertain, treat or stimulate a bird within a cage. The most common product, which has long been de rigueur for a birdcage is a mirror that allows a bird to look at or observe itself. Other products attempt to provide interactive entertainment. The interactive products are usually effective for a duration of time, but once a bird has figured out how the interaction occurs, and what to expect, the bird will typically lose interest and no longer interact with the product. For intelligent birds such as parrots, the interest time is often short since the bird quickly figures out the product.

Other products have offered an alternate way of presenting a bird with food or a treat. These products are popular with a bird as a result of the bird receiving a desired reward. Unfortunately, most of these products are simply food or treat dispensers which are used in addition to the bird's usual food and water dispensers/bowls.

What is needed is a product that would provide interactive entertainment and stimulus, along with the reward option of presenting a treat. A product such as this would encourage a bird to interact with the product, even after the bird is familiar with the operation since the bird will receive the reward of a treat. A bird will learn that a successful interaction with the product will result in the reward of a treat every time, which will ensure the bird repeatably, and optimally in new and difference ways, to interact.

A search of the prior art did not disclose any literature or patents that read directly on the claims of the instant invention. However, the following U.S. patents are considered related:

| PATENT NO. | INVENTOR | ISSUED |
|---|---|---|
| 2,487,087 | Anderson | Nov. 8, 1949 |
| 8,733,285 | Taber | May 27, 2014 |
| 2006/0225664 | Zych | Oct. 12, 2006 |

The U.S. Pat. No. 2,487,087 discloses a device which is adapted to attract birds and furnish them with entertainment while feeding, to provide novel and unusual means of enjoyment for the birds as well as for on-lookers. The device has various movable parts that are actuated by the energy exerted by the bird, and the device is simple in construction comprising only a few parts that can be assembled easily. The device is durable and well adapted to function outdoors in all kinds of weather, and is constructed so its operation cannot cause injury to the bird.

The U.S. Pat. No. 8,733,285 disclose a bird-operated interactive bird feeder that attracts birds and dispenses a substantially predetermined amount of bird feed (e.g., bird seed) when a bird operates a tool. Bird feed is held in storage in a feed hopper above a stage. An aperture is provided in the bottom of the housing large enough for the enclosed feed to flow freely from the housing to the stage. When a bird operates the tool, the feed flows for a period of time, and then rebuilds the feed when the bird ceases operation of the tool.

The 2006/0225664 publication discloses a method and apparatus for exercising, educating, amusing, and feeding animals. The apparatus encourages an animal to access educational, recreational, exercise, and amusement devices by configuring the apparatus such that the animal is most comfortable when it is eye level with the devices. Additionally, defecation on the devices and food or water receptacles is minimized due to strategic placement of the devices. The invention, educational, recreational, exercise and amusement device also provide the animal with feeling of accomplishment and productivity.

For background purposes and indicative of the art to which the invention relates, reference may be made to the following remaining patents found in the patent search.

| PATENT NO. | INVENTOR | ISSUED |
|---|---|---|
| 173,506 | Biddall | Feb. 15, 1876 |
| 371,226 | Lee | Oct. 11, 1887 |
| 1,791,175 | Tomlinson | Feb. 3, 1931 |
| 2,531,915 | Maly | Nov. 28, 1950 |
| 2,800,105 | Ilg | Jul. 23, 1950 |
| 4,542,714 | Ingraham, et al | Sep. 24, 1985 |
| 5,022,345 | Bolivar, et al | Jun. 11, 1991 |
| 5,479,878 | Coulter | Jan. 2, 1996 |
| 6,736,088 | McGregor, et al | May 18, 2004 |
| 7,426,903 | Simon | Sep. 23, 2008 |
| 2006/0027183 | Woltmann, et al | Feb. 9, 2006 |
| 2006/0060154 | Wesely | Mar. 23, 2006 |
| 2016/0286761 | Ruckel, et al | Oct. 6, 2016 |

### DISCLOSURE OF THE INVENTION

In its basic design the pressure/activated bird entertainment and treat dispensing system is comprised of a structure that is placed within a birdcage; either hung, placed on a horizontal surface, or attached to a vertical surface. Alternately, the structure can be used outside of a birdcage on occasions when a bird is released from the birdcage.

The structure comprises multiple designs that utilize at least one pressure activating mechanism of which there are various well-known type of mechanism. The design of each of the structures provides visual stimulation for a bird and bird owner, as well as tactile stimulation for the bird. Each structure is unique and presents various geometric and non-geometric shapes, curves and angles, which are interesting to look at (for a bird and bird owner) and provide a bird with many options for standing on, grasping, pecking and/or otherwise engaging. Preferably, the structure is made of a durable, easy to clean and maintain material such as plastic, although other materials including wood and metal can also be utilized.

Depending on the shape(s) and size of a particular structure, a food or treat dispensing apparatus is located at the top, bottom; middle or on a side of the structure. The dispensing apparatus functions in combination with the pressure activating mechanism as previously disclosed. Again, the type of mechanism that is utilized depends on the functionality of; and location of, the dispensing apparatus. For example, one design provides a structure with an actuating plate adjacent a food item or treat located at the top of the structure on an upper end of a tube or channel. A mechanism is used so that when a bird applies pressure by pushing on an actuating plate with his beak or claw/feet, the food/treat is released and allowed to fall downward through the tube or channel. At the bottom of the structure the tube or channel opens, thereby allowing the food/treat to fall onto or into a location where the bird can easily use his break or claws to grab the food/treat.

By providing both a visually and tactilely entertaining structure, along with the reward of food or a treat, the system will be an engaging learning and entertainment means that a bird will consistently return to and not lose interest in quickly.

In view of the above disclosure, the primary object of the invention is to provide a pressure activated bird entertainment and treat dispensing system that will provide a bird with both an interactive learning environment along with a form of entertainment that results in a reward, and thereby will be used and enjoyed by a bird and bird owner(s) for a long time.

In addition to the primary object, it is also an object of the invention to provide a pressure activated bird entertainment and treat dispensing system that:
can be used and enjoyed by many types of birds,
has multiple structural options,
is easy for a bird owner to set-up,
can withstand abuse such as pecking, scratching or hitting from a bird,
is available in a variety of sizes for large or small birds and large or small birdcages,
does not interfere with or replace conventional feeding systems,
is easy to clean and maintain
can be sold as an aftermarket product or along with a birdcage,
can be permanently or non-permanently placed/attached in a birdcage,
is cost effective from both a manufacturer's and bird owner's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic front view of a pressure activated bird entertainment and treat dispensing system (PBETS).

FIG. 2 is an elevational front view of the front view of the PBETS as shown in as shown in FIG. 1.

FIG. 3 is an orthographic front view of an additional structural design of the PBETS.

FIG. 4 is an elevational front view of the PBETS as shown in FIG. 3.

FIG. 5 is an elevational front view showing a PBETS structure as a nature or outdoor scene.

FIG. 6 is an elevational front view showing a PBETS structure as an artistic design.

FIG. 7 is an elevational front view showing a PBETS structure as an artistic design.

FIG. 8 is an elevational front view showing a PBETS structure as a mountain scene.

FIG. 9 is an elevational front view showing a PBETS structure as a nature or outdoor scene.

FIG. 10 is an elevational front view showing a PBETS structure as a stylized animal.

FIG. 11 is an elevational front view showing a PBETS structure as a structural design.

FIG. 12 is an elevational front view showing a PBETS structure as an artistic design.

FIG. 13 is an elevational front view showing a PBETS structure as a structural design.

FIG. 14 is an elevational front view showing a PBETS structure as an artistic design.

FIG. 15 is an elevational front view showing a PBETS structure as a structural design.

FIG. 16 is an elevational front view showing a PBETS structure as a stylized animal.

FIG. 17 is an elevational front view showing a PBETS structure as a structural design.

FIG. 18 is an elevational front view showing a PBETS structure as an artistic design.

FIG. 19 is an elevational front view showing a PBETS structure as a mountain scene.

FIG. 20 is an elevational front view showing a PBETS structure as a structural scene.

FIG. 21 is an elevational front view showing a PBETS structure as an artistic design.

FIG. 22 is an elevational front view showing a PBETS structure as an amusement park ride.

FIG. 23 is an elevational front view showing a PBETS structure as a mountain scene.

FIG. 24 is an elevational front view showing a PBETS structure as a nature or outdoor scene.

FIG. 25 is an elevational front view showing a PBETS structure as a mountain scene.

FIG. 26 is an elevational front view showing a PBETS structure as an artistic design.

FIG. 27 is an elevational front view showing a PBETS structure as a nature or outdoor scene.

FIG. 28 is an elevational front view showing a PBETS structure as a household item.

FIG. 29 is a block diagram showing the electronic components of the PBETS.

FIG. 30 is a block diagram showing the sensors used for the PBETS electronic functionality.

FIG. 31 is a top plan view of a typical design of the PBETS treat dispenser.

FIG. 32 is a block diagram showing the PBETS manual operation.

FIG. 33 is a block diagram showing a PBETS motor driven operation.

### BEST MODE FOR CARRYING OUT THE INVENTION

The best mode for carrying out the invention is presented in terms that disclose a preferred embodiment, with multiple design configurations, of a pressure activated bird entertainment and treat dispensing system 10, (PBETS). Although dogs and cats are the predominant animals kept as domestic pets, other animals can also be kept. One such animal is a bird, which can range in size from a small type such as a parakeet, to a larger type such as a parrot. Regardless of the size of a bird, it is important to provide a bird with stimulation, especially since a bird spends a great majority of time within a cage. In order to provide stimulation, it is common to see items such as a swing and/or a mirror within a cage. While these items do provide a limited amount of stimulation, it would be beneficial to provide a bird with an item that requires interaction to produce a desired reward such as a food treat. A bonus would be if the bird stimulation would also be enjoyable for humans to observe as a bird interacts. The PBETS provides this exact type of interactive bird entertainment, along with the reward of a food treat when an action is successfully accomplished. The PBETS 10 provides repeated entertainment since the outcome of an action can vary and provides enjoyment to people watching a bird attempt to figure out a solution, which a bird typically eventually does.

In this pressure activated embodiment, the PBETS 10 provides a bird with an edible treat upon completion of an action requiring pressure applied from the bird. The PBETS offers entertainment, exercise, visual stimulation, and audible stimulation to a bird, and entertainment, visual stimulation, and audible stimulation to an observer.

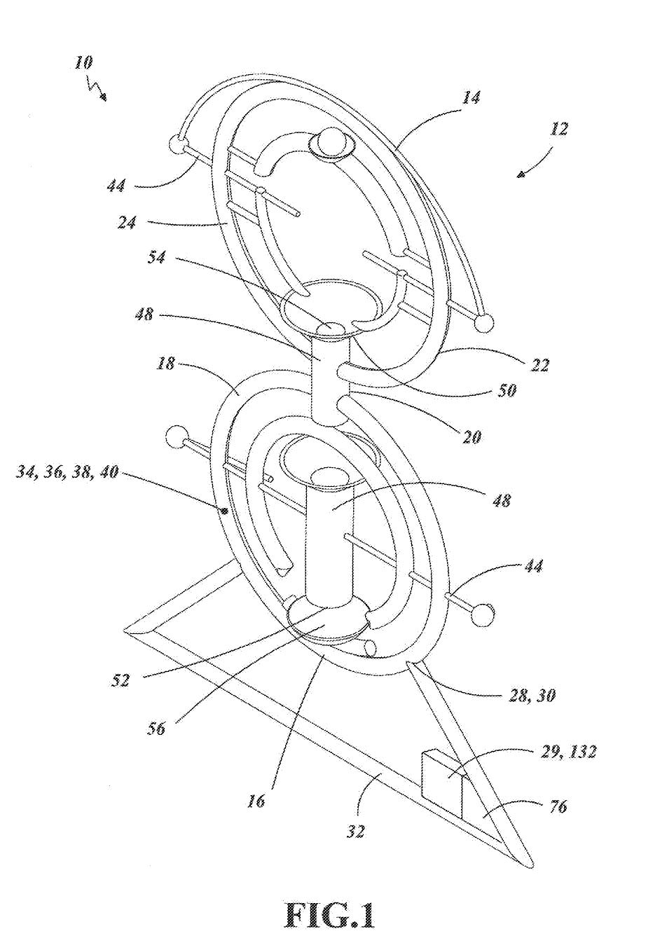

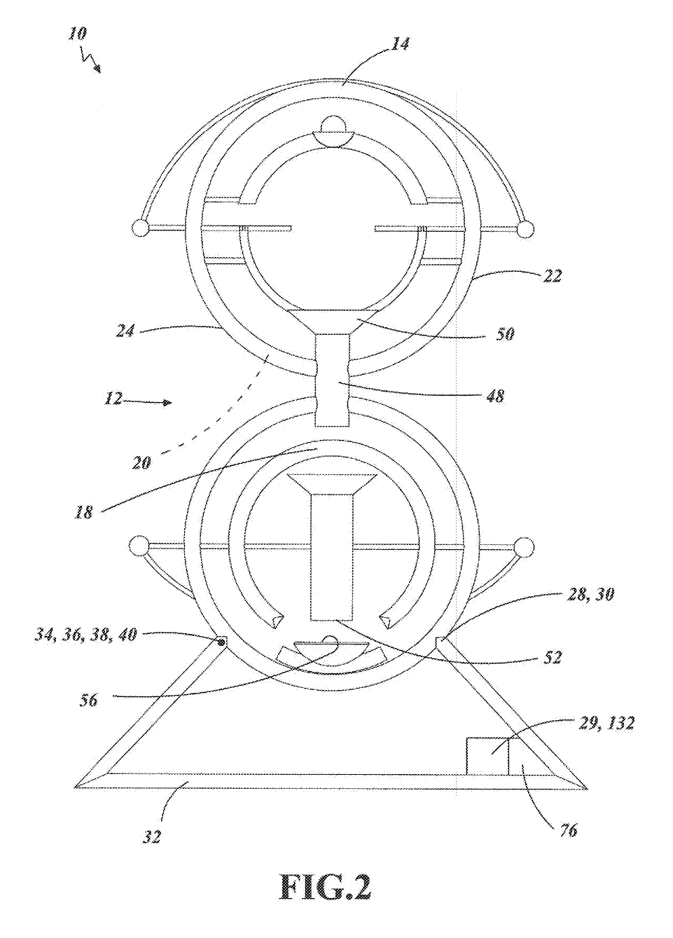

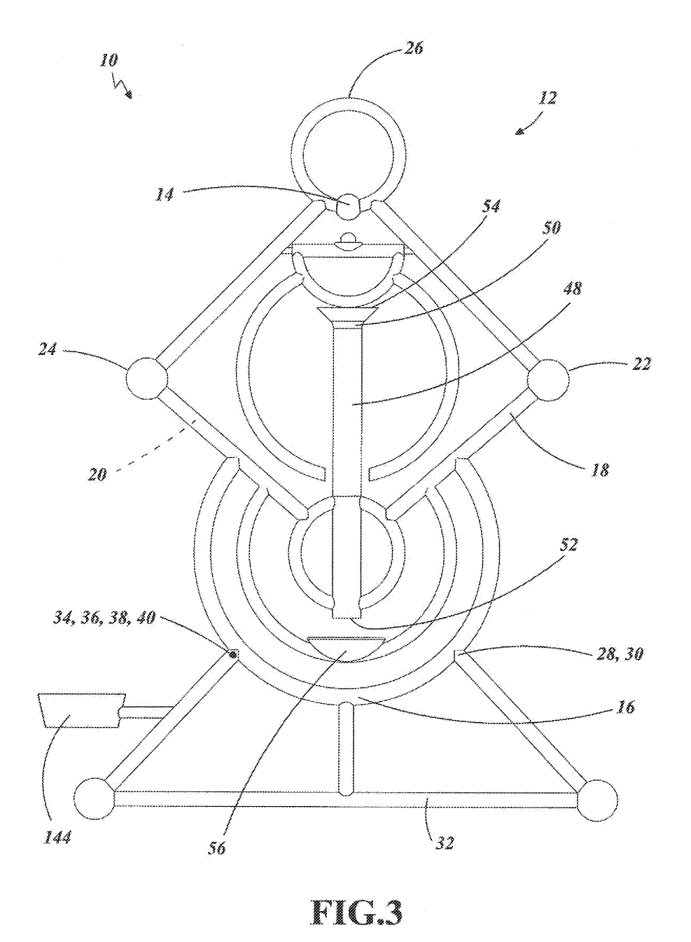

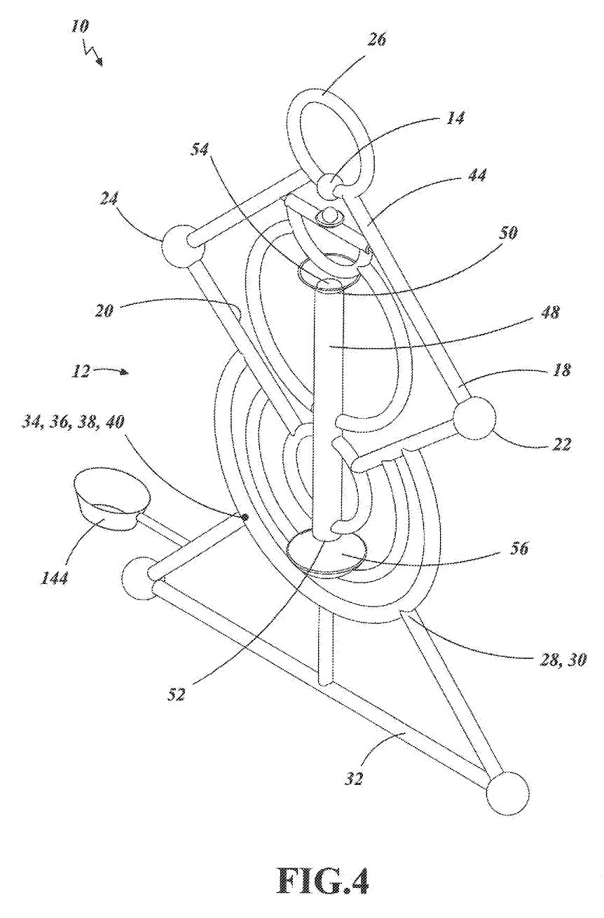

In a general sense, the PBETS 10, as shown in FIGS. 1-33, is comprised of a structure 12, with a supporting base 20. The structure 12 is designed to be placed within a birdcage, or placed on a surface outside of a birdcage for the times when a bird is allowed out of the cage. When the structure 12 is within a birdcage, the structure 12 can be placed on the lower surface/floor of the cage, attached to a side surface, or hung from an upper surface. To facilitate hanging the structure 12, a support member 26 such as a ring, as shown in FIGS. 3 and 4, can be utilized. The structure 12, as shown in FIGS. 1-4, typically includes an upper end 14, a lower end 16, a front surface 18, a rear surface 20, a right side 22, and a left side 24. Depending on the exact configuration of a particular structure 12 not all of the above elements are necessarily utilized, as will be shown. The base 28, as shown in FIGS. 1-4, can be comprised of an upper end 30 and a lower end 32. Again it should be noted that the design and functionality of the base 28 is determined by the configuration of the structure 12. Certain structure configurations require a pronounced, substantial base that provides significant support, while other structure configurations require a minimal base 28. The base 28 can be attached to the structure 12 by attachment means 34 such as at least one screw 26, at least one bolt and nut 38, or an adhesive 40, or the base 28 can integrally attached to the structure 12.

The structure 12 can be made of various materials including plastic, metal or wood, or a combination of these materials. The structure 12 can also be vertically oriented or horizontally oriented, and can have a theme or design selected from the group consisting of a nature or outdoor scene 58, an artistic design 60, a mountain scene 62, a stylized animal 64, a structural design 66, an amusement park ride 68, or a household item 70.

The structure 12 usually includes at least one perch 42, at least one arm 44, and at least one platform 46. The structure 12 also includes at least one treat tube 48 with an upper end 50 and a lower end 52. Located at the upper end 50 is an opening 54 dimensioned to allow a treat to fit within and travel through the treat tube 48, a cavity 56 located below the open lower end. The cavity 56 catches and retains the treat until the bird takes the treat.

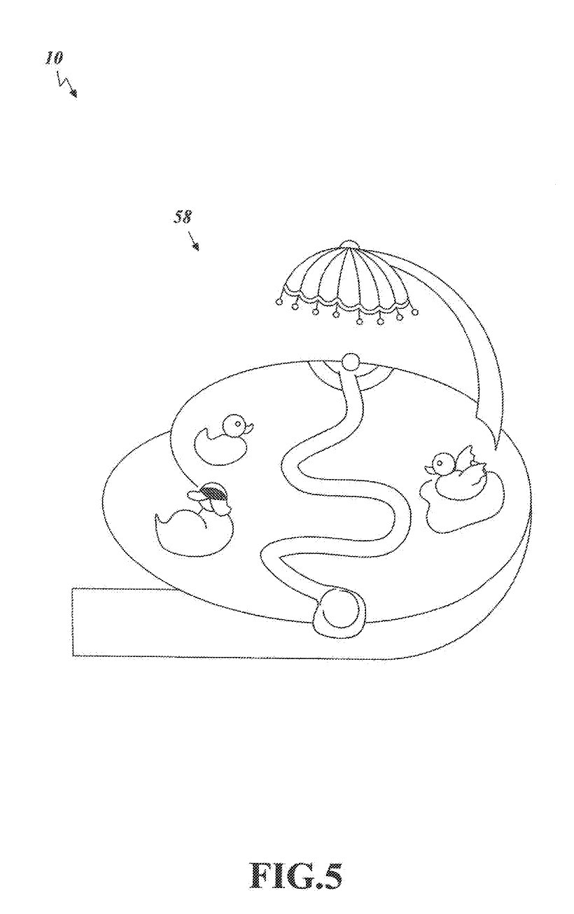

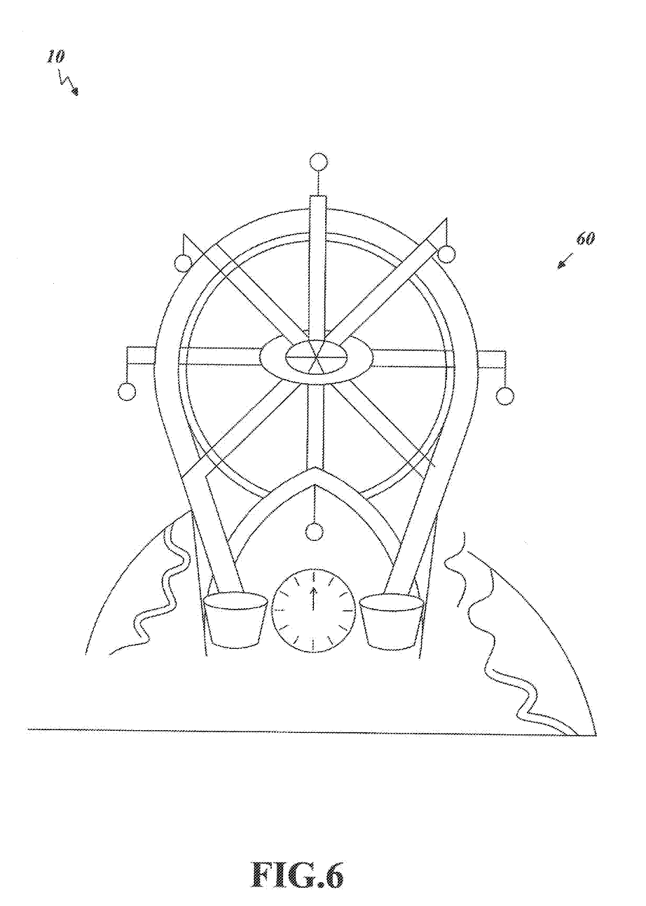

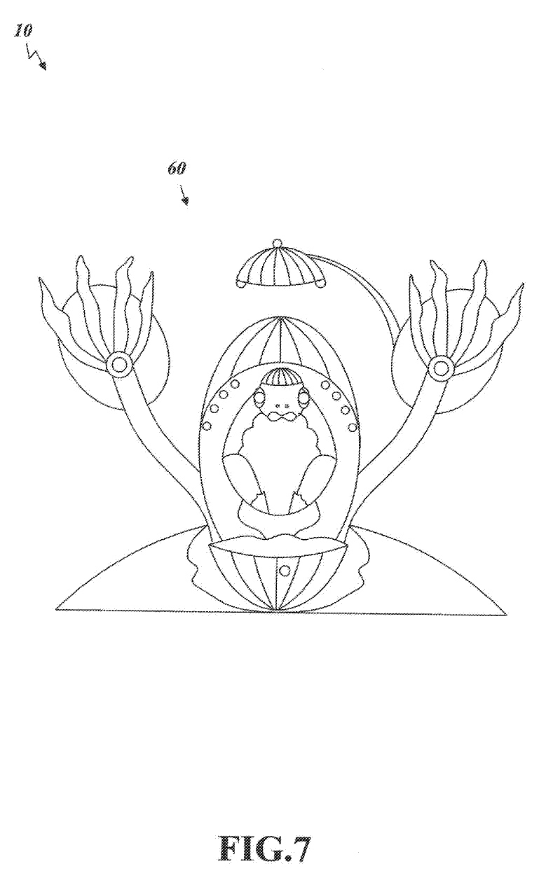

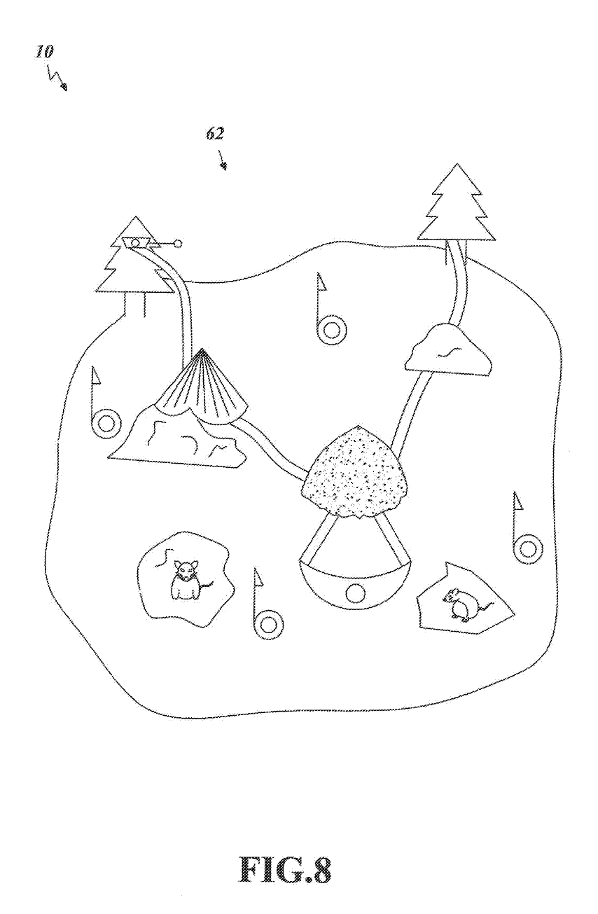

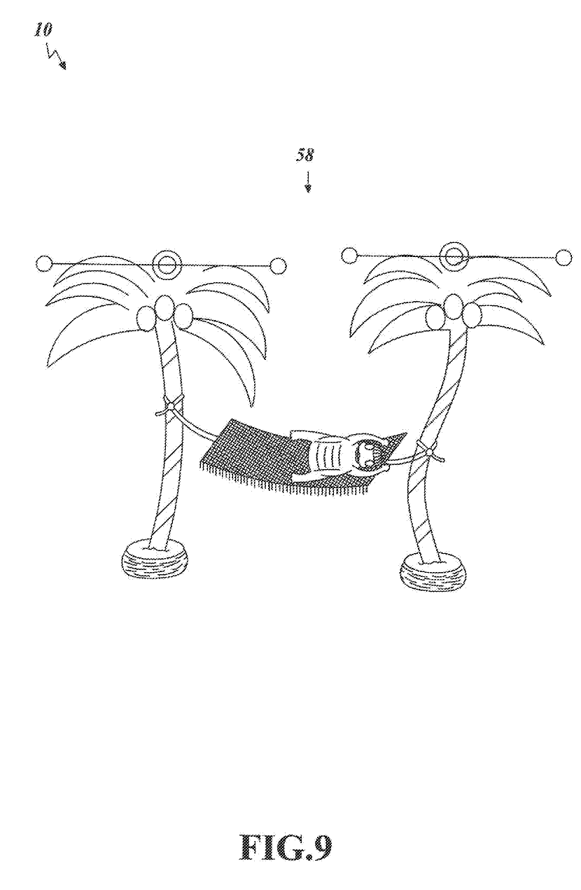

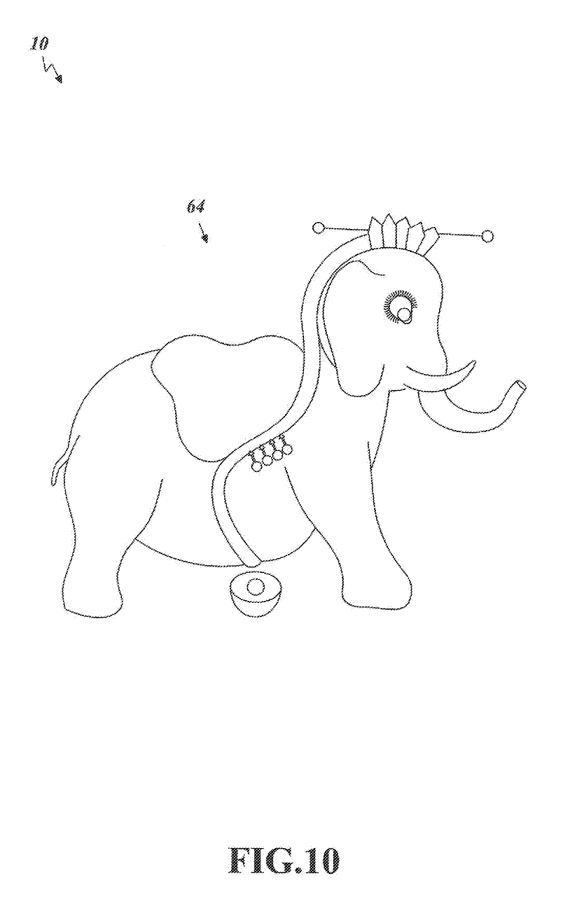

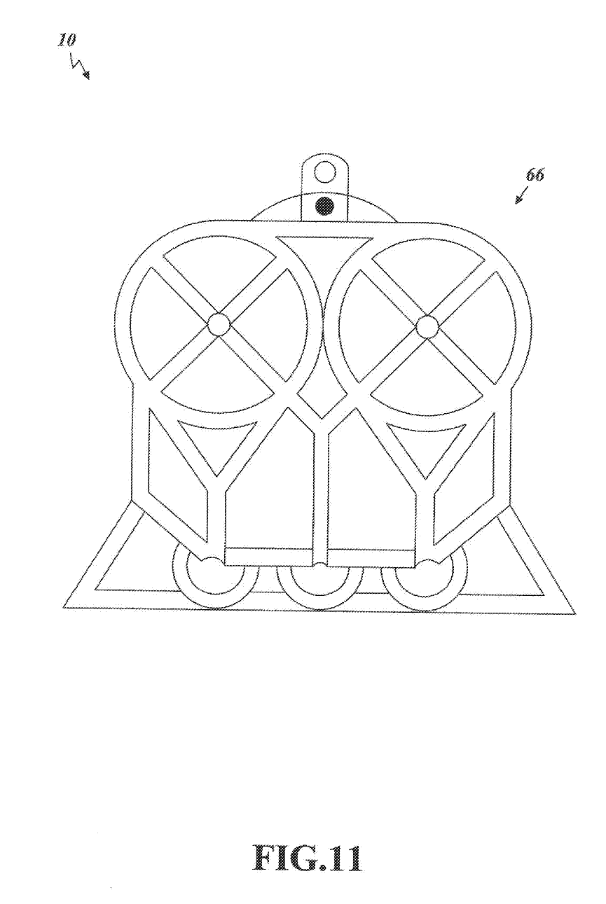

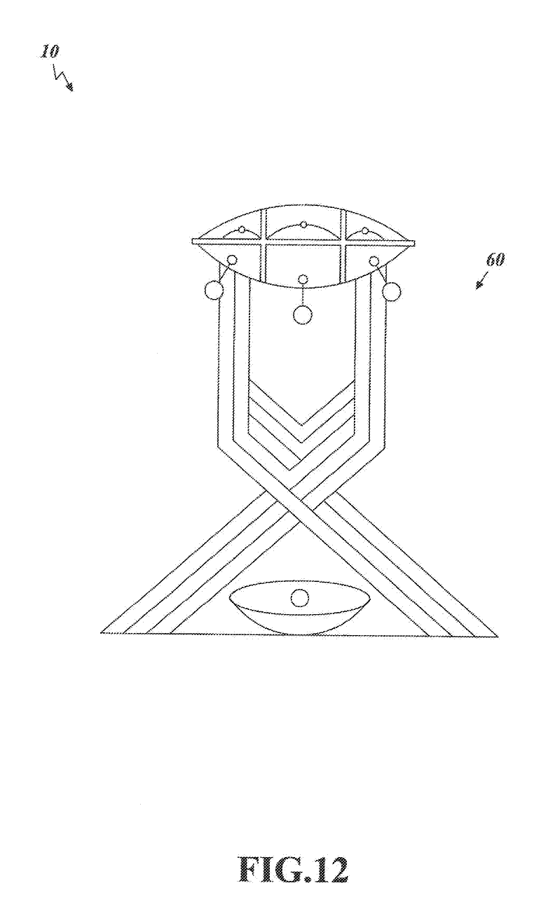

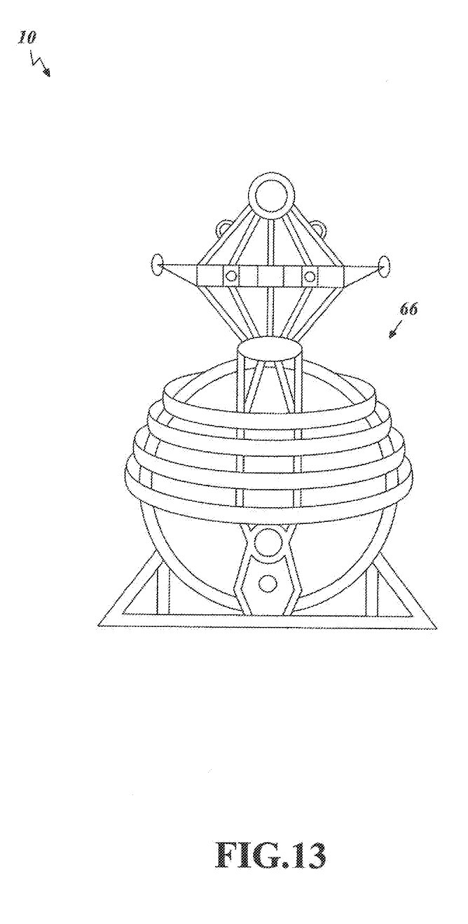

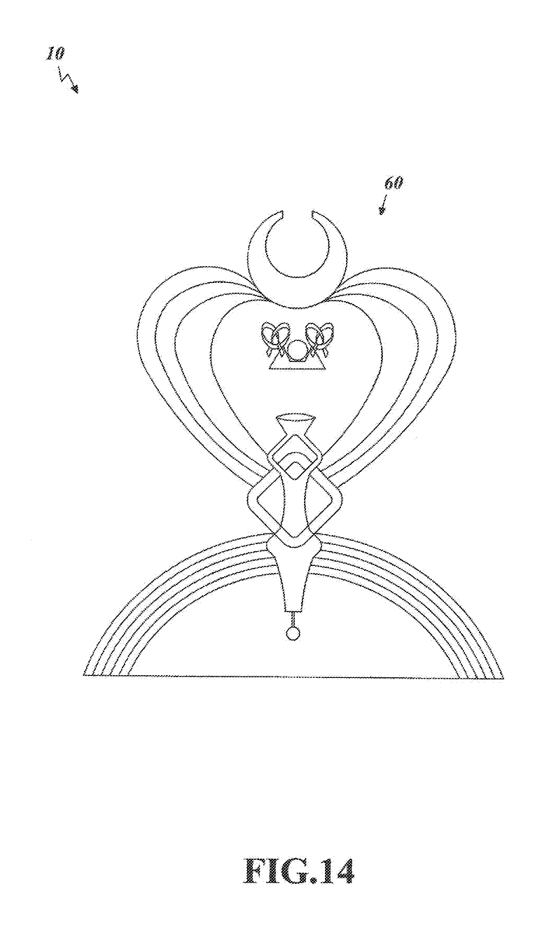

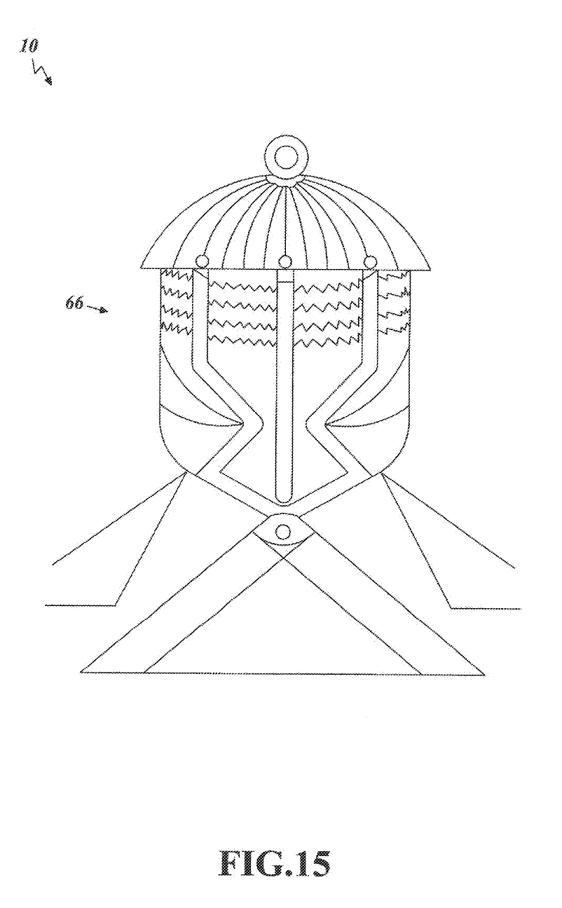

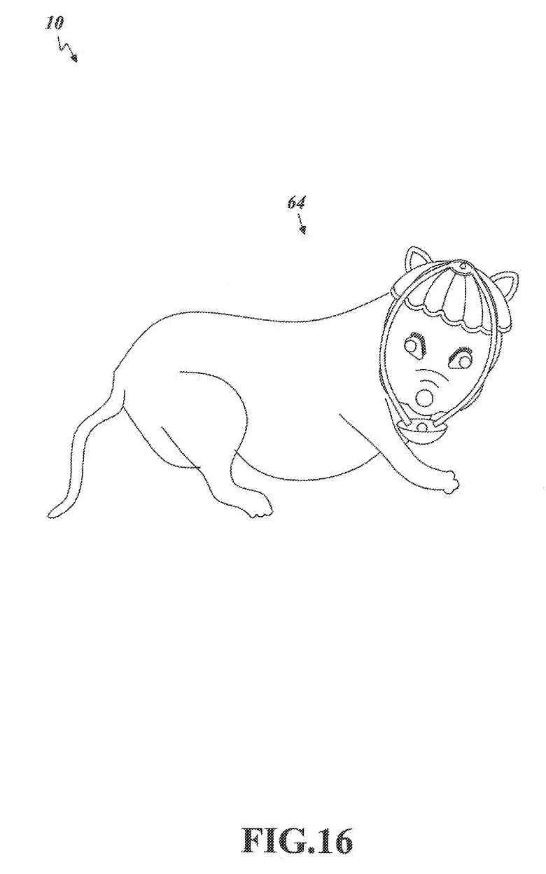

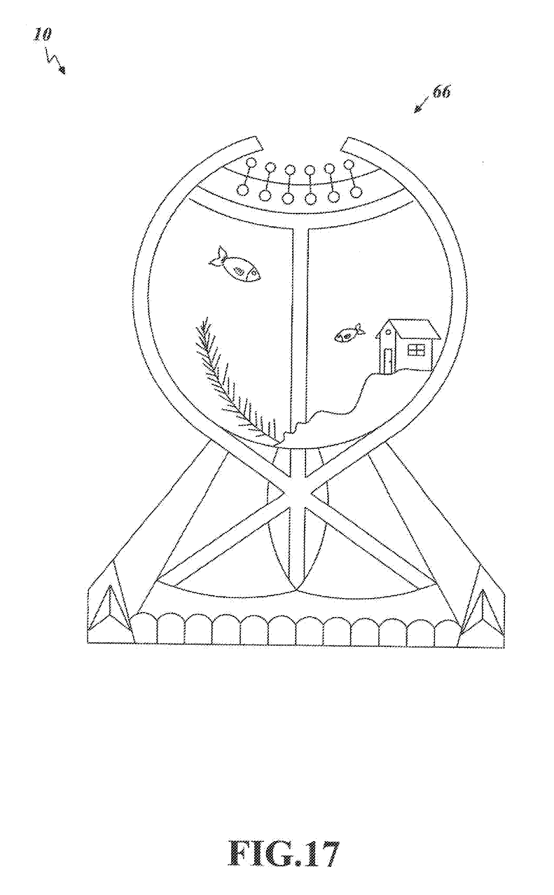

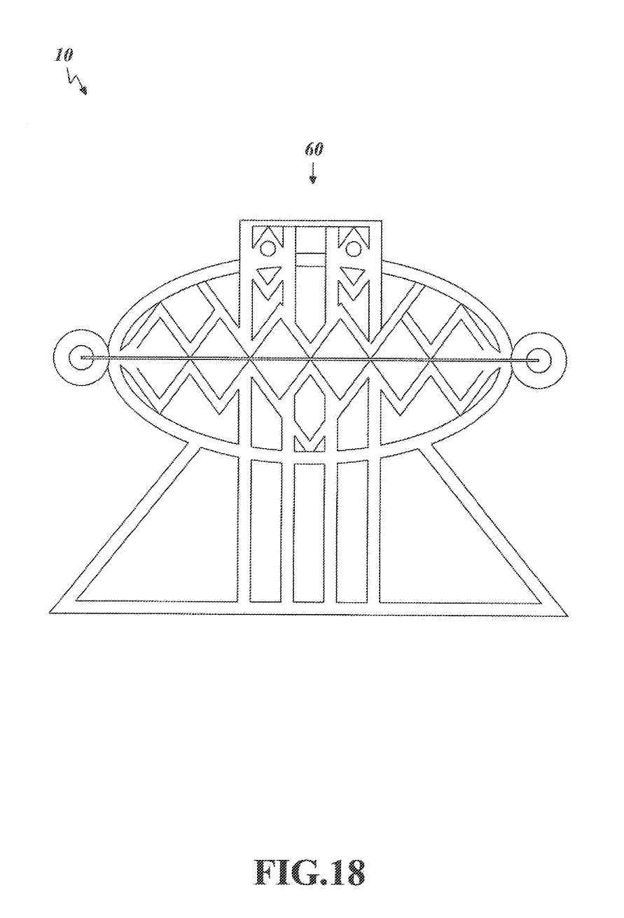

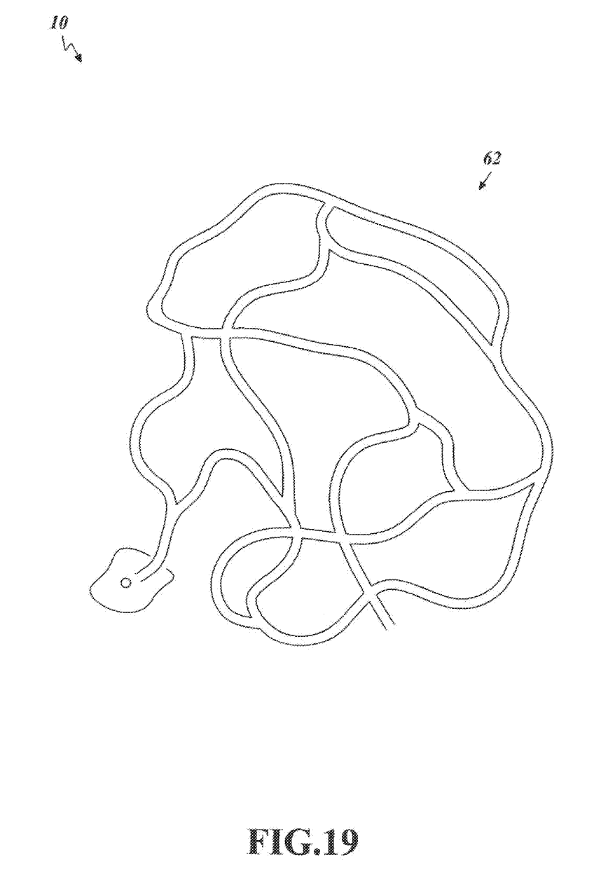

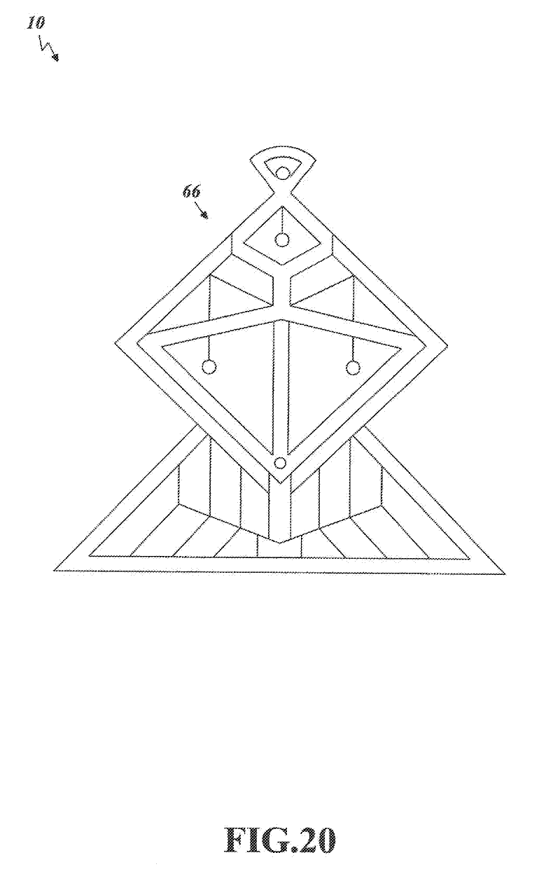

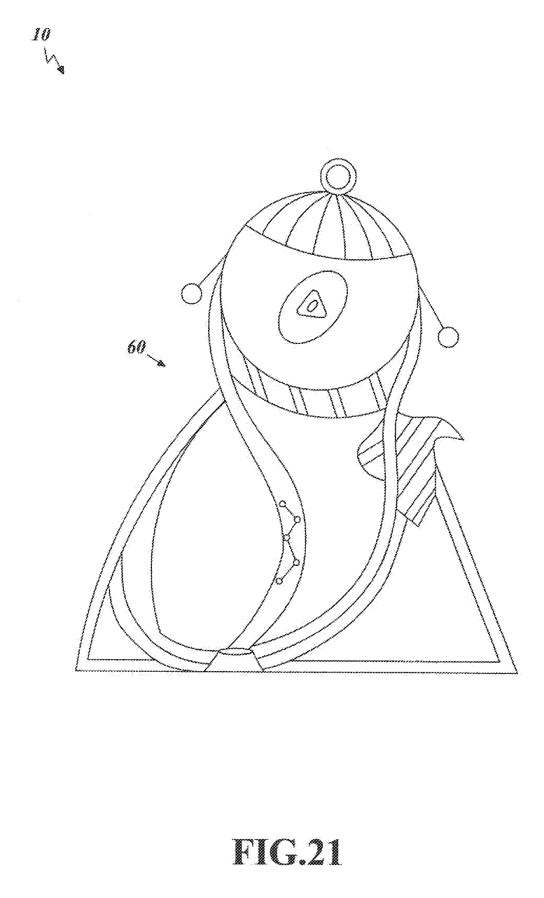

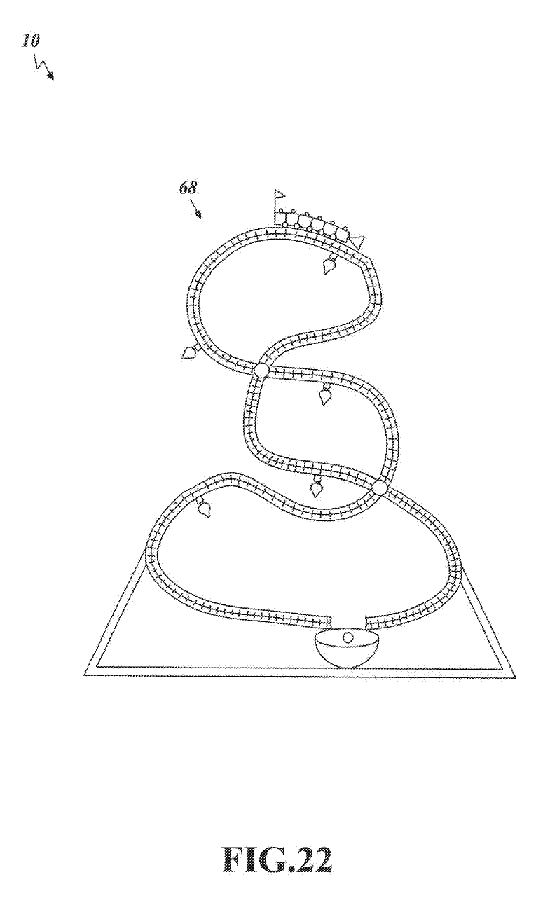

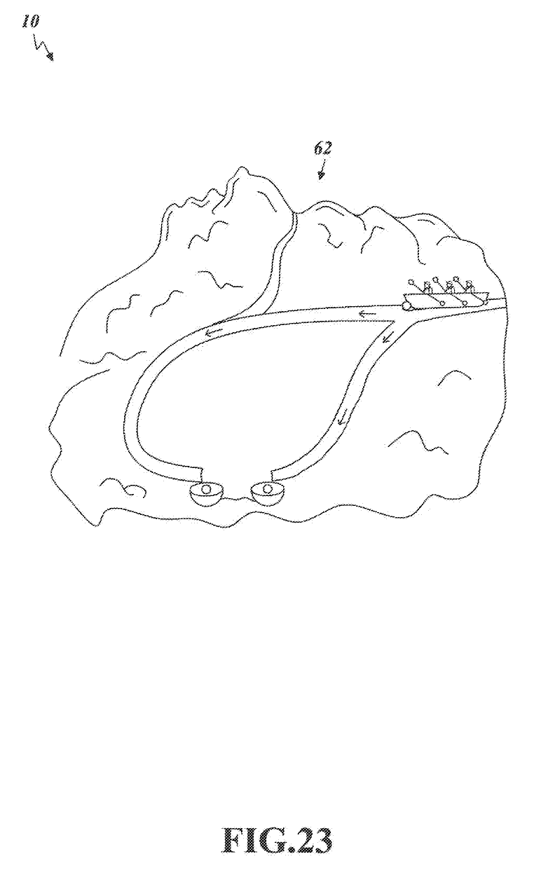

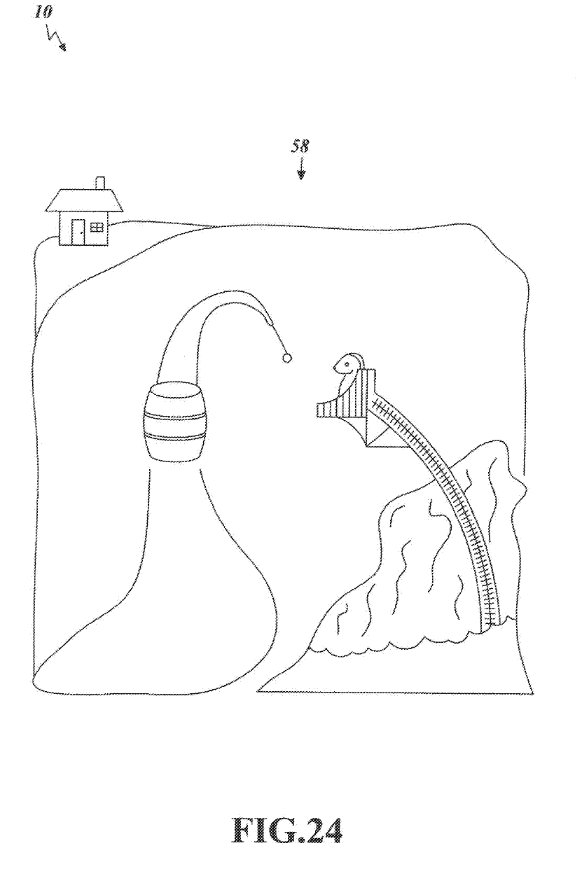

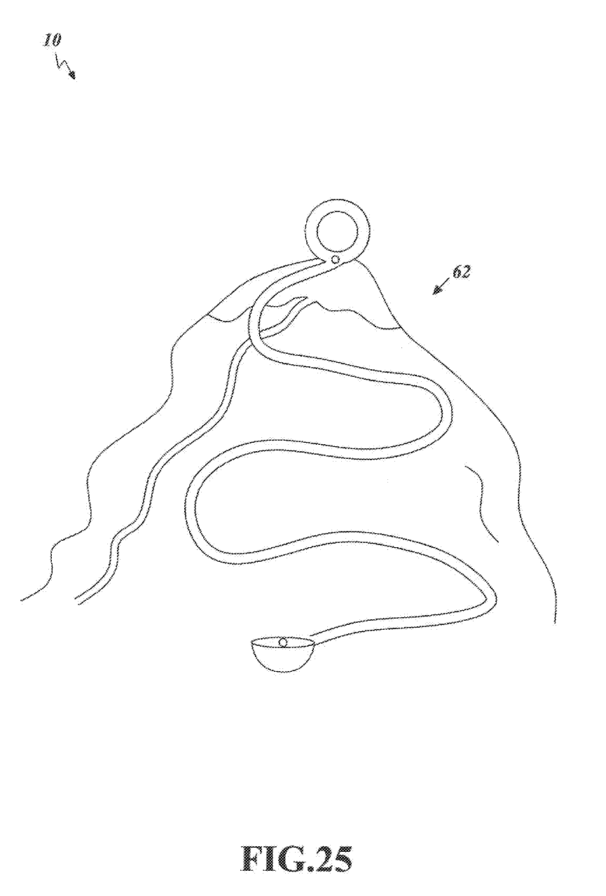

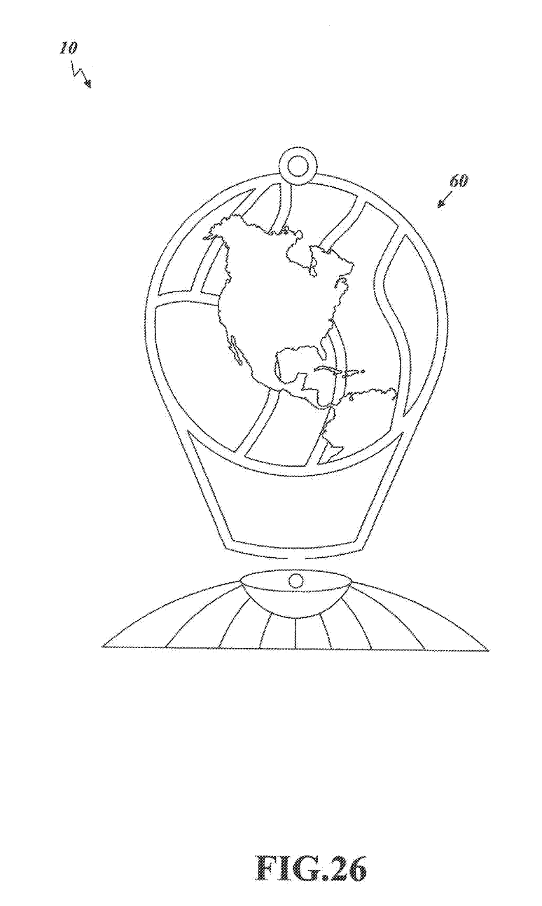

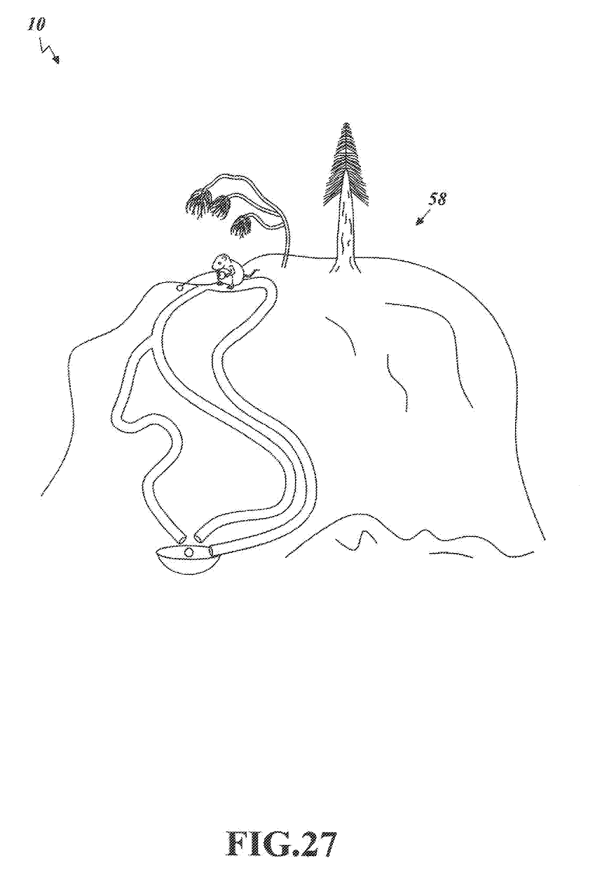

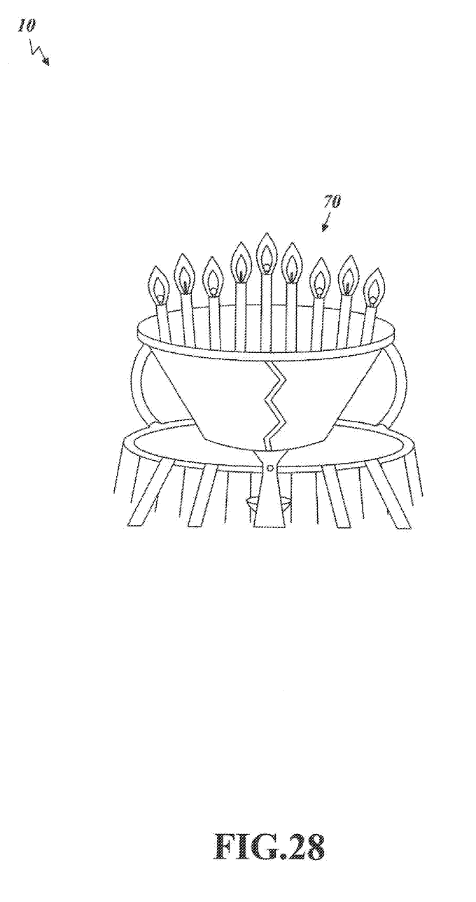

Depending on the type of structure 12, the action requiring pressure from the bird includes break pressure, claw pressure, feet pressure, or weight pressure. The pressure also includes pulling or pushing, for example, pulling on a chain or cord, or pushing on a surface, structural element or a button. The entertainment, exercise, visual stimulation and audible stimulation, both for a bird and an observer includes structural components for the bird to climb, lights, bells, sounds from a speaker, moving objects, and moving structural members, which can be seen various implementations in FIGS. 5-28, with a nature or outdoor scene 58 shown in FIG. 5, an artistic design 60, as shown in FIG. 6, an artistic design 60, as shown in FIG. 7, a mountain scene 62, as shown in FIG. 8, a nature or outdoor scene 58, as shown in FIG. 9, a nature or outdoor scene 64, as shown in FIG. 10, a structural design 66, as shown in FIG. 11, an artistic design 60, as shown in FIG. 12, a structural design 66, as shown in FIG. 13, an artistic design 60, as shown in FIG. 14, a structural design 60, as shown in FIG. 15, a stylized animal 64, as shown in FIG. 16, a structural design, as shown in FIG. 17, an artistic design 60, as shown in FIG. 18, a mountain scene 62, as shown in FIG. 19, a structural design 66, as shown in FIG. 20, an artistic design 60, as shown in FIG. 21, an amusement park ride 68, as shown in FIG. 22, a mountain scene 62, as shown in FIG. 23, a nature or outdoor scene 58, as shown in FIG. 24, a mountain in scene 62, as shown in FIG. 25, an artistic design 60, as shown in FIG. 26, a nature or outdoor scene 58, as shown in FIG. 27 or a household item 70, as shown in FIG. 28.

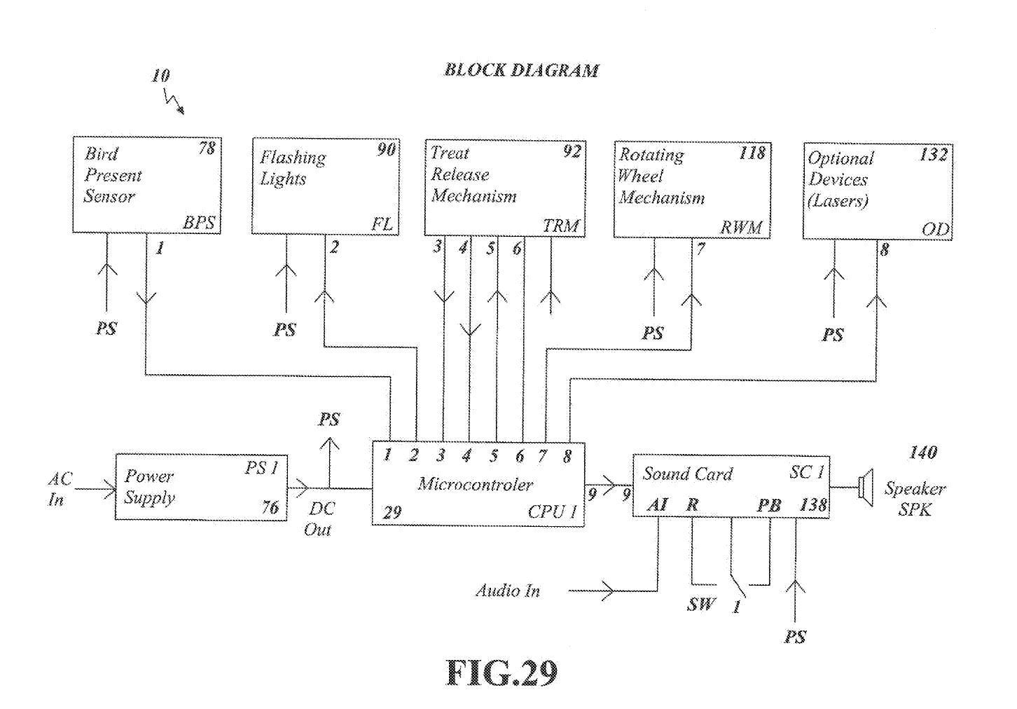

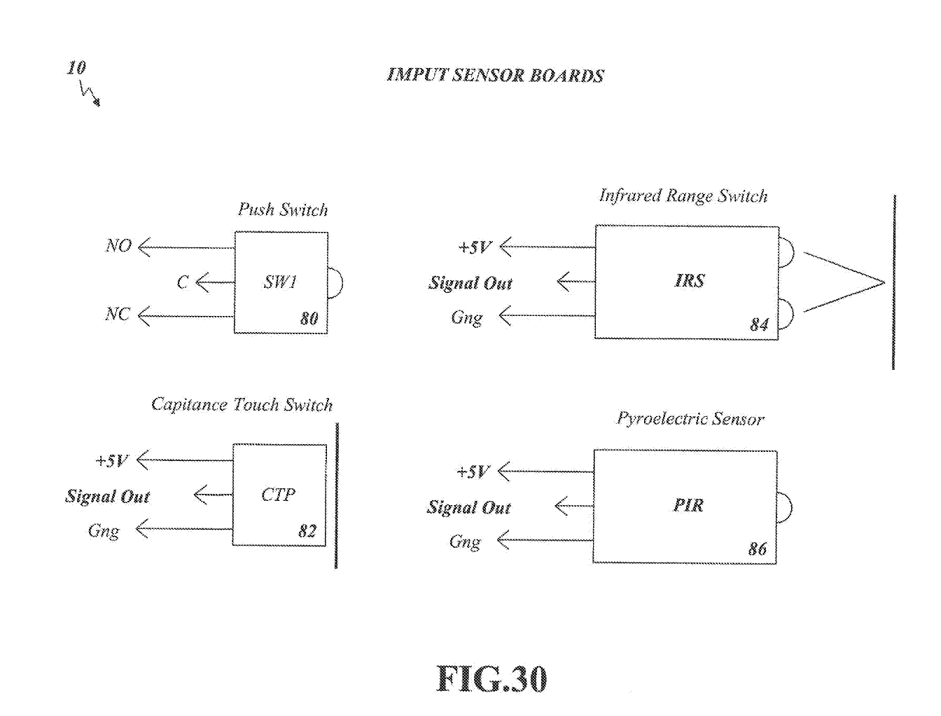

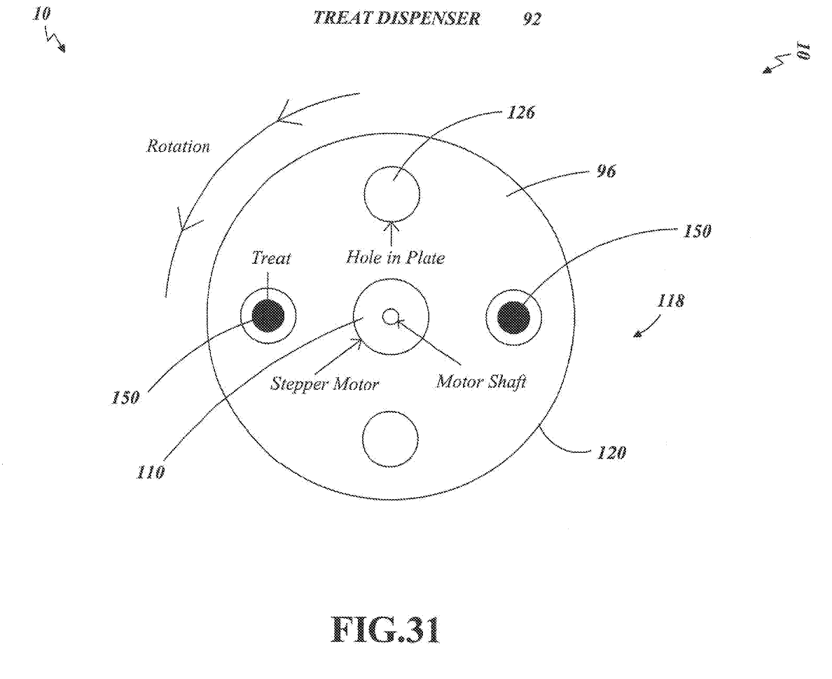

In order for the PBETS 10 to function, the pressure applied from a bird activates either a bird present sensor 78, a pressure sensor 80, a capacitance and touch sensor 82, an infrared sensor 84, or a pyroelectric sensor 86, as shown in FIGS. 29 and 30. A microcontroller 74, as shown in FIG. 29, within the structure 12 operates a treat release mechanism 92. When a bird applies pressure onto a component of the structure 12, the treat release mechanism 92 allows a treat 150 to travel from a first location to a second location usually through the treat tube 64 from where the bird is able to access the treat. One example of the operation of the treat dispensing mechanical utilizes a rotation method, as shown in FIG. 31. The microcontroller 74 also controls a motor in a motor driven mechanism 108 that operates moving objects, moving structural member(s) and the treat release mechanism 92. The microcontroller 74 is powered by a power supply 76, as shown in FIG. 29, which is preferably comprised of a 5-volt DC 2-amp regulated power supply.

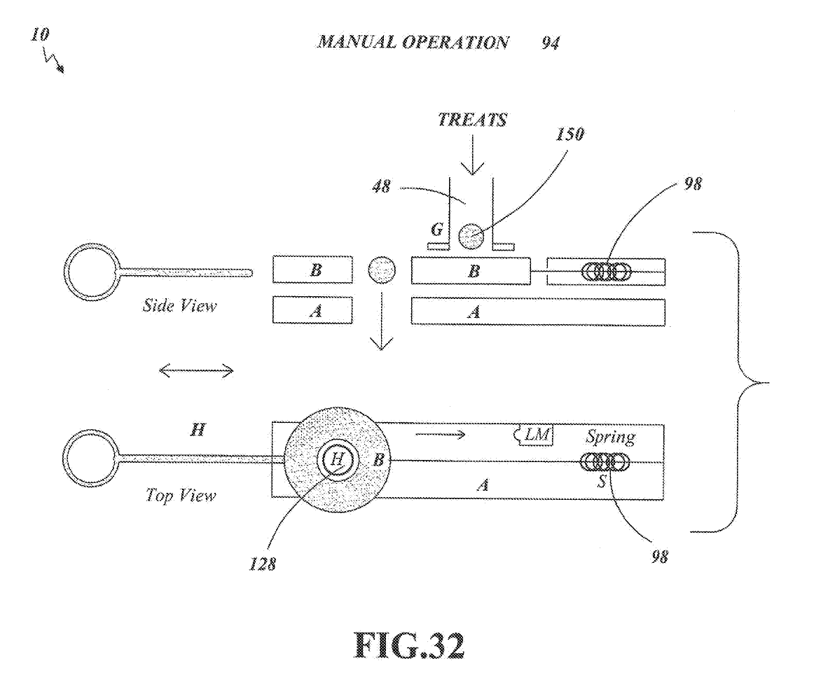

The treat release mechanism 92 is comprised of a manual mechanism 94 or the previously disclosed motor driven mechanism 108. The manual treat release mechanism 94, as shown in FIG. 32, functions with at least one treat tube 48. The manual mechanism 94 comprises a plate 96 having an opening 54, a spring 98 and a locking mechanism 100. The plate 96 is pulled back by the spring 98 and locked in that position by the locking mechanism 100. The opening 54 in the plate 96 corresponds to the opening 54 in the treat tube 48, and is in a rear position with the opening below a treat holder in which a treat 150 is placed and maintained. The locking mechanism 100 prevents the treat 150 being released until a bird performs a pressure action. Once a bird applies pressure and activates a sensor, the microcontroller 74 releases the locking mechanism 100 which allows the treat 150 to enter and fall through the treat tube's upper end 50, and out through the lower end 52 to a receptacle from which the treat 150 is accessed and retrieved by the bird. The locking mechanism 100 is comprised of a solenoid 102 or a magnet 104.

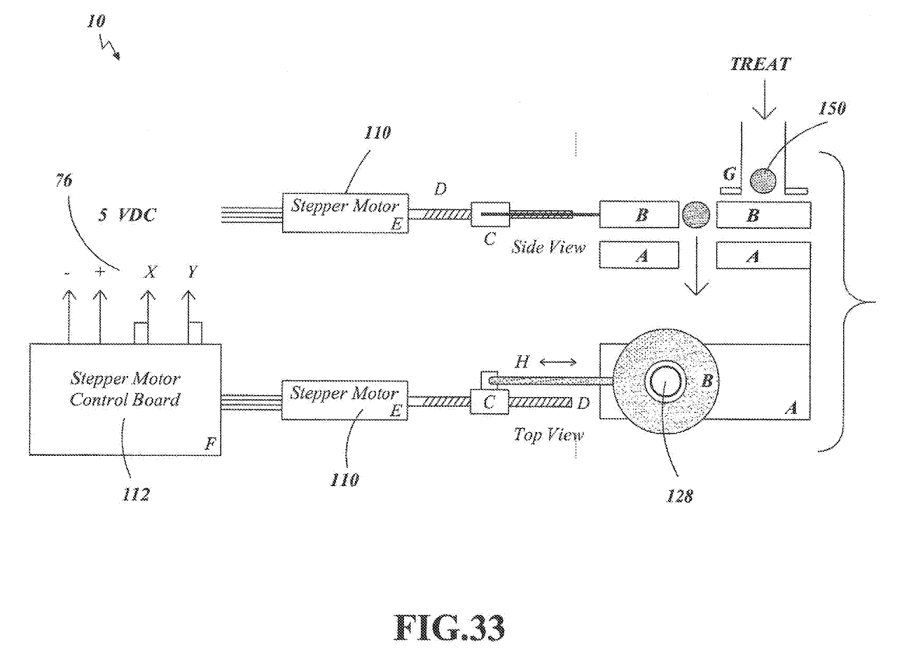

The motor driven treat release mechanism 108, as shown in FIG. 33, also functions with at least one treat tube 42, and is comprised of a stepper motor 110 that is controlled by the microcontroller 74 via a stepper motor control board 112. Once a bird applies pressure and activates a sensor 78,80,82, the microcontroller 74 turns on the motor which pulls back a plate 96. The plate 96, as shown in FIG. 31, pulled back allows a treat to enter and fall through the treat tube upper end, out through the lower end 52, to a receptacle from which the treat is accessed and retrieved by a bird. The microcontroller 70 then reverses the stepper motor direction which returns the plate 96 to a closed position. The stepper motor control board is comprised of a H bridge control board, as shown in FIG. 33.

As additional visual or audible stimulation for a bird or onlooker(s), various items can be included on the structure and as components of the electronic circuit. For example, a flashing light board 88 controls the operation of at least one flashing (or non-flashing) light 90, as shown in FIG. 29; a sound card 138 provides sounds that are heard through a speaker 140, as also shown in FIG. 29; or a laser diode produces laser effects which are optimally used with at least one mirror 134.

To increase the functionality of the PBETS 10, at least one bowl or similar container can be included with the structure 12. The bowl 144 is used to hold a quantity of bird food or water, and preferably two bowls 144 are utilized, with one bowl holding food and the other holding water. The bowl 144 is typically attached at a lower section of the structure 12. When possible, the bowl 144 is attached to the base 28, as shown in FIG. 3. Depending on the requirements, the bowl 144 can either be attached by attachment means such as screw(s) or being integrally molded with the structure or base, or removably attached by attachment means such as a clip(s) or a male to female device. It should be noted that when food is placed in the bowl 144, the food consists of the common, everyday bird food that the bird is accustomed to. This food must not be the same as the treat 150 dispensed from the PBETS 10. If the bird food and treat 150 are the same, there will be no impetus for the bird to perform the necessary action(s) on the structure.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A pressure activated bird entertainment and treat dispensing system (PBETS) that provides a bird with an edible treat upon completion of an action requiring pressure applied from the bird, wherein said PBETS offers entertainment, exercise, visual stimulation, and audible stimulation to a bird, and entertainment, visual stimulation and audible stimulation to an observer, wherein said PBETS is comprised of a structure with a supporting base, and at least one treat tube, wherein a microcontroller within said structure operates a treat release mechanism, wherein when a bird applies pressure onto an element of said structure, said treat release mechanism allows a treat to travel from a first location to a second location, through the treat tube, wherein the bird is able to access and retrieve the treat from the second location.

2. The pressure activated bird entertainment and treat dispensing system as specified in claim 1 wherein said structure is made of a material selected from the group consisting of plastic, metal, wood and a composite.

3. The pressure activated bird entertainment and treat dispensing system as specified in claim 1 wherein said structure is vertically oriented.

4. The pressure activated bird entertainment and treat dispensing system as specified in claim 1 wherein said structure is horizontally oriented.

5. The pressure activated bird entertainment and treat dispensing system as specified in claim 1 wherein said structure has a theme selected from the group consisting of an outdoor scene, a nature scene, a structural design, a mountain scene, an amusement park ride design or an artistic design.

6. The pressure activated bird entertainment and treat dispensing system as specified in claim 1 wherein said base is attached to said structure by attachment means.

7. The pressure activated bird entertainment and treat dispensing system as specified in claim 6 wherein the attachment means are selected from the group consisting of at least one screw, at least one bolt and nut or an adhesive.

8. The pressure activated bird entertainment and treat dispensing system as specified in claim 1 wherein said base is integral with said structure.

9. The pressure activated bird entertainment and treat dispensing system as specified in claim 1 wherein the action requiring pressure applied from the bird is selected from the group consisting of beak pressure, claw pressure, feet pressure, or weight pressure.

10. The pressure activated bird entertainment and treat dispensing system as specified in claim 1 wherein the entertainment, exercise, visual stimulation and audible stimulation is selected from the group consisting of structural designs for a bird to climb, lights, bells, sounds from a speaker, moving objects, and moving structural members.

11. The pressure activated bird entertainment and treat dispensing system as specified in claim 1 wherein the pressure applied from the bird activates a sensor that is selected from the group consisting of a bird present sensor, a pressure sensor or a capacitance and touch sensor.

12. The pressure activated bird entertainment and treat dispensing system as specified in claim 1 wherein said microcontroller controls a motor that operates moving objects, moving structural member sand said treat released mechanism.

13. The pressure activated bird entertainment and treat dispensing system as specified in claim 1 wherein said microcontroller is powered from a power supply.

14. The pressure activated bird entertainment and treat dispensing system as specified in claim 13 wherein the power supply is comprised of a 5-volt DC 2-amp regulated power supply.

15. The pressure activated bird entertainment and treat dispensing system as specified in claim 1 wherein said treat release mechanism is comprised of a manual mechanism or a motor driven mechanism.

16. The pressure activated bird entertainment and treat dispensing system as specified in claim 15 wherein said manual treat release mechanism functions with said at least one treat tube, having an upper end and a lower end, wherein said manual mechanism comprises a plate having an opening, a spring and a locking mechanism, wherein the plate is pulled back by the spring and locked in that position by the locking mechanism, wherein the opening in the plate is in a rear position and the opening is below a treat holder is which a treat is placed and maintained, wherein the locking mechanism prevents the treat being released until a bird performs a pressure action, wherein once a bird applies pressure and actuates a sensor, said microcontroller release the locking mechanism which allows the treat to enter and fall through the treat tube's upper end, and lower end to a receptacle from which the treat is accessed and retrieved by the bird.

17. The pressure activated bird entertainment and treat dispensing system as specified in claim 16 wherein the locking mechanism is comprised of a solenoid or a magnet.

18. The pressure activated bird entertainment and treat dispensing system as specified in claim 16 wherein the locking mechanism is comprised of a magnet.

19. The pressure activated bird entertainment and treat dispensing system as specified in claim 15 wherein said motor driven treat release mechanism functions with said at least one treat tube including an upper end and a lower end, wherein said motor driven mechanism is comprised of a stepper motor that is controlled by the microcontroller via a stepper motor control board, wherein once a bird applies pressure and actuates a sensor, said microcontroller turns on the motor which pulls back a plate, wherein the plate pulled back allows a treat to enter and fall through the treat tube upper end and lower end to a receptacle from which the treat is accessed and retrieved by a bird, wherein said microcontroller then reverses the stepper motor direction which returns the plate to a closed position.

20. The pressure activated bird entertainment and treat dispensing system as specified in claim 19 wherein the stepper motor control board is comprised of a H bridge driven board.
